(19) United States
(12) Patent Application Publication
(10) Pub. No.: US 2019/0254270 A1
(43) Pub. Date: Aug. 22, 2019

(54) CARPENTER BEE TRAP

(71) Applicants: Brian Robert Blazer, Heflin, AL (US); Bradley Jerome Blazer, Granite Falls, NC (US)

(72) Inventors: Brian Robert Blazer, Heflin, AL (US); Bradley Jerome Blazer, Granite Falls, NC (US)

(21) Appl. No.: 16/262,491

(22) Filed: Jan. 30, 2019

Related U.S. Application Data
(60) Provisional application No. 62/623,721, filed on Jan. 30, 2018.

(51) Int. Cl. A01M 1/10

(52) U.S. Cl. CPC A01M 1/106; A01M 2200/012

(57) ABSTRACT

A carpenter bee trap is provided to aid in the protection of structures from carpenter bee infestation. The carpenter bee trap includes an enclosure with an interior that is divided into an entrance chamber and a trap chamber by a divider. A portion of the enclosure is adapted to allow ambient light to enter the trap chamber, and the divider is sized and positioned so as to provide a gap that allows ambient light to enter the entrance chamber and that also allows bees to access the trap chamber from the entrance chamber. At least one hole extends from an outside surface of the enclosure to the entrance chamber and acts as a primary attractant for carpenter bees. Once bees enter the entrance chamber through the hole(s), they are attracted to the ambient light in the trap chamber, where they are trapped. A portion of the enclosure is preferably adapted to allow easy access to the trap chamber for removing the trapped bees.

### STATEMENT OF RELATED CASES

This application claims priority to U.S. Provisional Application Ser. No. 62/623,721, filed Jan. 30, 2018, whose entire disclosure is incorporated herein by reference.

### FIELD OF THE INVENTION

The present invention relates to flying insect traps and, more particularly, to traps for carpenter bees.

### BACKGROUND OF THE INVENTION

Most carpenter bees, Xylocopa spp., are large and robust insects resembling bumble bees. They are usually about 1 inch long and colored a metallic blue-black with green or purplish reflections. They differ from bumble bees in that their abdomen is shiny with fringes of hairs on some segments. Males of some species are lighter colored, ranging into golden or buff hues. Female carpenter bees bore into sound wood or sometimes into decaying wood to make nests.

Nests usually consist of tunnels ½ inch in diameter and 6 to 10 inches deep that are partitioned into several chambers, each containing an egg and a supply of food (pollen). The tunnel entrance has been noted to slope upward, commonly a near vertical opening in the side or bottom surface of a Wooden member. Carpenter bees may use old tunnels for their nests, which they sometimes enlarge. Further, several bees may use a common entry hole connecting to different tunnels. Over a period of time, tunnels may extend as far as 10 feet into wood timbers.

Tunnels are vacated after the brood's larval and pupal stages complete their development. Development from egg to adult may take about 3 months. Carpenter bees overwinter as adults, often in old tunnels, and there is only one generation a year.

Carpenter bees cause damage to wooden structures by boring into timbers and siding to prepare nests. The nests weaken structural wood and leave unsightly holes and stains on building surfaces. Woodpeckers feeding on carpenter bee larvae multiply the damage by tearing open the nests.

Sound, undecayed wood without paint or bark is usually selected for nests. Farm structures that feature exposed unpainted rafters are particularly susceptible to infestation. Since the bees do not eat the wood, lumber that is naturally insect resistant or treated to resist insects is susceptible to infestation. In testing and field observations, carpenter bees were most attracted to Juniperus virginiana wood of the Cupressaceae family, presumably since the aromatic insect-resistant nature of the wood repels parasites of the bees.

Standing dead Juniperus virginiana trees are conspicuous as sites of carpenter bee colonies in the southeastern United States. Carpenter bees also frequently attack dead wood on trees or lumber from southern yellow pine, white pine, California redwood, cedar, Douglas fir, cypress, mimosa, mulberry, ash, and pecan trees. They avoid most harder woods. The presence of carpenter bees around buildings and wooden structures can be annoying or even frightening, however, males cannot sting and females rarely attack.

### SUMMARY OF THE INVENTION

An object of the invention is to solve at least the above problems and/or disadvantages and to provide at least the advantages described hereinafter.

The present invention provides a carpenter bee trap to aid in the protection of structures from carpenter bee infestation. The carpenter bee trap includes an enclosure with an interior that is divided into an entrance chamber and a trap chamber by a divider. A portion of the enclosure is adapted to allow ambient light to enter the trap chamber, and the divider is sized and positioned so as to provide a gap that allows ambient light to enter the entrance chamber and that also allows bees to access the trap chamber from the entrance chamber.

At least one hole extends from an outside surface of the enclosure to the entrance chamber and acts as a primary attractant for carpenter bees. Once bees enter the entrance chamber through the hole(s), they are attracted to the ambient light in the trap chamber, where they are trapped. A portion of the enclosure is preferably adapted to allow easy access to the trap chamber for removing the trapped bees.

An embodiment of the invention is a carpenter bee trap, comprising an enclosure; a divider positioned inside the enclosure for dividing an interior of the enclosure into an entrance chamber and trap chamber, wherein at least a portion of the enclosure is adapted to allow ambient light to enter the trap chamber; and at least one hole extending from an outside surface of the enclosure to the entrance chamber; wherein the divider is sized and positioned so as to provide a gap that allows carpenter bees to access the trap chamber from the entrance chamber.

### BRIEF DESCRIPTION OF THE DRAWINGS

The invention will be described in detail with reference to the following drawings in which like reference numerals refer to like elements wherein:

FIG. 1 is a perspective view of a carpenter bee trap, in accordance with an illustrative embodiment of the present invention;

FIG. 2 is side view of the carpenter bee trap of FIG. 1, in accordance with an illustrative embodiment of the present invention;

FIG. 3A is sectional view of the carpenter bee trap of FIGS. 1 and 2 taken along the section line A-A of FIG. 2 for one illustrative embodiment of a divider; and

FIG. 3B is sectional view of the carpenter bee trap of FIGS. 1 and 2 taken along the section line A-A of FIG. 2 for another illustrative embodiment of a divider.

### DETAILED DESCRIPTION OF PREFERRED EMBODIMENTS

In the following detailed description of various embodiments of the system and method of the present invention, numerous specific details are set forth in order to provide a thorough understanding of various aspects of one or more embodiments. However, the one or more embodiments may be practiced without some or all of these specific details. In other instances, well-known methods, procedures, and/or components have not been described in detail so as not to unnecessarily obscure aspects of embodiments.

Articles “a” and “an” are used herein to refer to one or to more than one (i.e. at least one) of the grammatical object of the article. By way of example, “an element” means at least one element and can include more than one element. Unless otherwise defined, all technical terms used herein have the same meaning as commonly understood by one of ordinary skill in the art to which this disclosure belongs.

The drawing figures are not necessarily to scale and certain features of the invention may be shown exaggerated in scale or in somewhat schematic form in the interest of clarity and conciseness. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion.

While preferred embodiments are disclosed, still other embodiments of the system and method of the present invention will become apparent to those skilled in the art from the following detailed description, which shows and describes illustrative embodiments. As will be realized, the following disclosure is capable of modifications in various obvious aspects, all without departing from the spirit and scope of the present invention. Also, the reference or non-reference to a particular embodiment of the invention shall not be interpreted to limit the scope of the present invention.

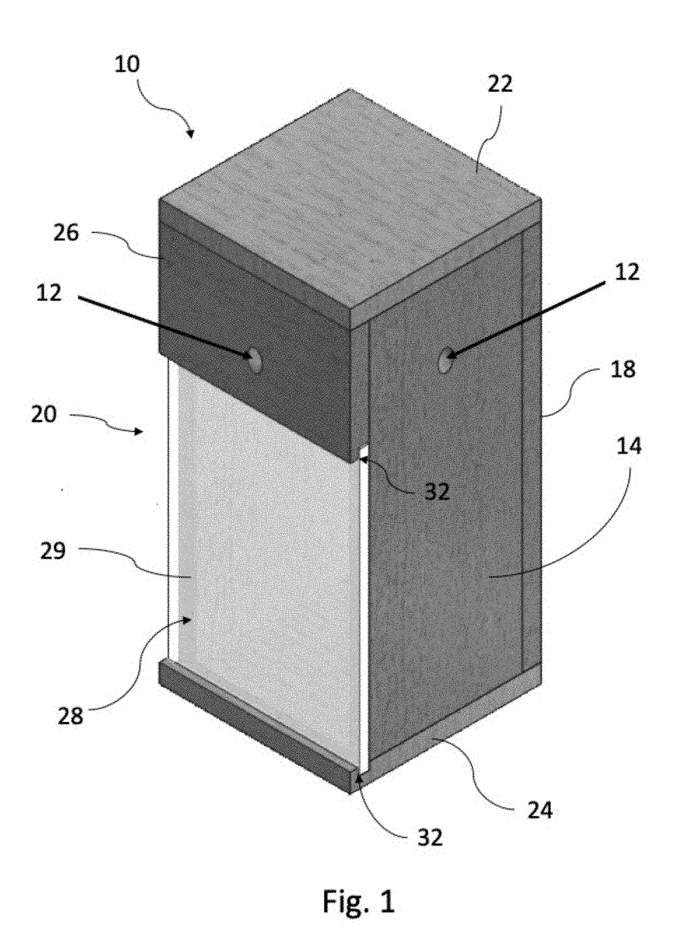

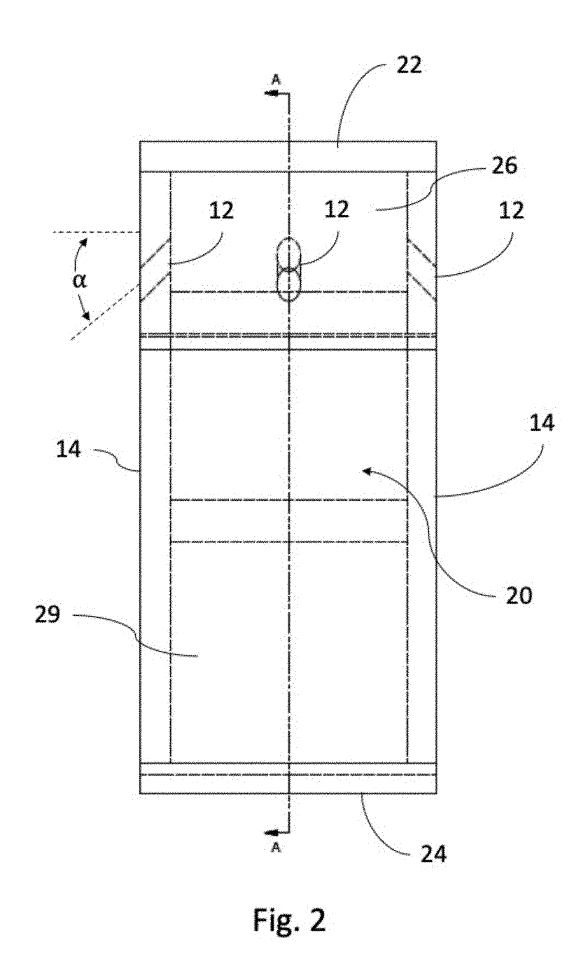

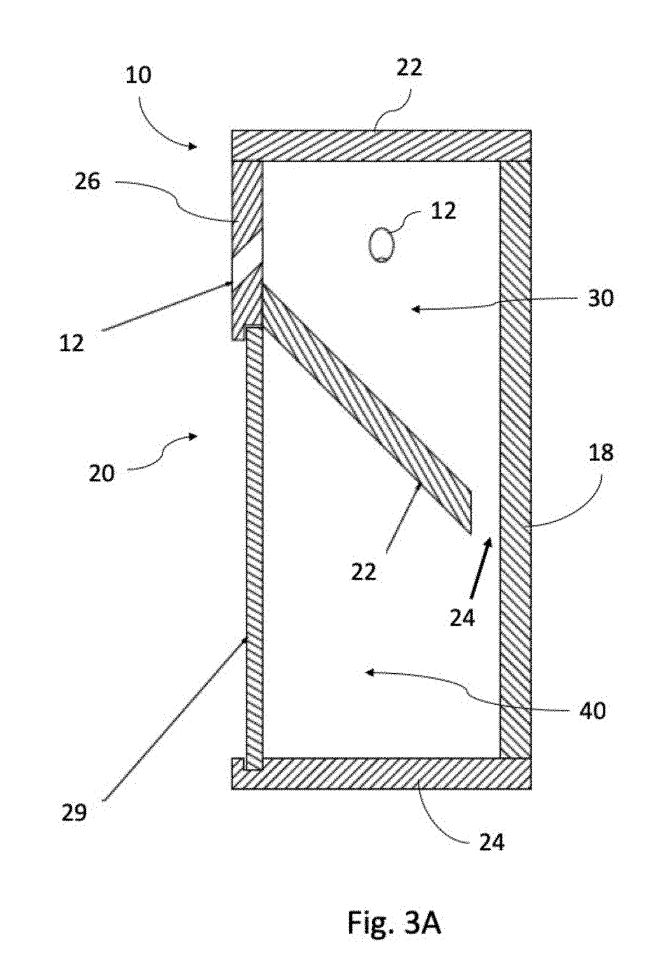

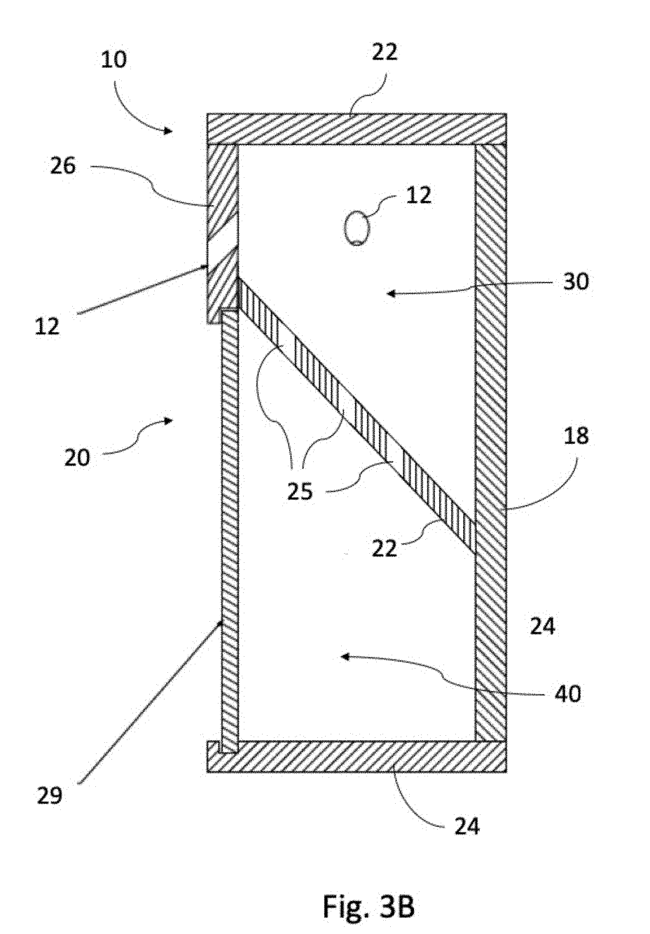

The present invention provides a carpenter bee trap to aid in the protection of structures from carpenter bee infestation. FIGS. 1, 2 and 3A show one illustrative embodiment of the present invention, and FIGS. 1, 2 and 3B show another illustrative embodiment of the present invention. FIG. 1 is a perspective view, FIG. 2 is a side view, and FIGS. 3A and 3B are sectional views taken along the section line A-A of FIG. 2 for a first and second embodiment, respectfully. The carpenter bee trap includes an enclosure 10, preferably formed of wood or a wood substitute. In the illustrative embodiments shown, the enclosure 10 is made up of two side panels 14, a back panel 18, a front panel 20, a top panel 22, and a bottom panel 24. The side panels 14, back panel 18, front panel 20, top panel 22 and bottom panel 24 are affixed together using any means known in the art, such as glue, nails, screws, etc.

A divider 22 (see FIGS. 3A and 3B) is positioned inside the enclosure 10 so as to divide an interior of the enclosure into an entrance chamber 30 and a trap chamber 40. The divider 22 is configured so as to provide one or more openings through which carpenter bees that enter the entrance chamber 30 can access the trap chamber 40. In the illustrative embodiment of FIG. 3A, divider 22 is sized and positioned so as to leave a gap 24 through which carpenter bees that enter the entrance chamber 30 can access the trap chamber 40. In the illustrative embodiment of FIG. 3B, divider 22 extends all the way across the width and depth of the interior of enclosure 10, however, one or more holes 25 are formed in the divider 22 through which carpenter bees that enter the entrance chamber 30 can access the trap chamber 40.

The divider 22 shown in FIGS. 3A and 3B is shown positioned in the enclosure 10 in an angled configuration (it is not parallel to the top and bottom panels 22 and 24). This is so that gravity will aid in the conveyance of bees that land on the divider 22 into the trap chamber 40. However, it should be appreciated that the divider 22 can also be positioned in a non-angled configuration such that it is perpendicular such that it is parallel to top and bottom panels 22 and 24.

At least one hole 12 is formed in the enclosure that extends from an outside surface of the enclosure 10 to the entrance chamber 30. In the illustrated embodiment, holes 12 are formed through three of the side panels 14 such that they extend from an outside surface of the respective side panel 14 to the entrance chamber 30.

A portion of the enclosure 10 is adapted to allow ambient light to enter the trap chamber 40. In the illustrated embodiment, the front panel 20 includes an entrance chamber section 26 and a trap chamber section 28. The trap chamber section 28 is adapted to allow ambient light to enter trap chamber 40. In the illustrated embodiment, the trap chamber section 28 of the front panel 20 is a window 29 made of an optically transparent material such as, for example, glass, plexiglass, plastic, etc. The window 29 is preferably movably attached so as to allow it to be selectively moved in order to gain access to the trap chamber 40 for removing dead carpenter bees. In the illustrated embodiment, the window 29 is adapted to slide along guides 32 formed on the bottom panel 24 and the entrance chamber section 26 of the front panel 20.

Although the illustrated embodiment utilizes a movable transparent window 29 as the trap chamber section 28 of the front panel 20, it should be appreciated that the trap chamber section 28 can be adapted to allow ambient light into the trap chamber 40 in other ways. For example, the trap chamber section 28 can be made of an opaque material that is perforated to allow ambient light into the trap chamber 40. As another example, the trap chamber section 28 can be made of a mesh material that allows ambient light to enter the trap chamber 40.

Although, in the illustrated embodiment, the window 29 is movably attached so as to allow it to be moved in order to gain access to the trap chamber 40, it could also be rigidly attached so as to not be movable and one or more of the side panels 14, back panel 18 and bottom panel 24 can be removably attached so as to allow for the selective removal of the panel in order to gain access to the trap chamber 40 for the removal of dead carpenter bees.

The enclosure 10, with the exception of the trap chamber section 28 of the front panel 20, is preferably made of wood or a wood substitute. However, it could be made of any other material, such as plastic or metal. If wood is used for the enclosure 10, the preferred wood is wood from a tree in the division Pinophyta and most preferably wood of a tree in the family Cupressaceae. The divider 22 can be made of wood, a wood substitute, metal, plastic or any other material.

The holes 12 are preferably sized, shaped and oriented to mimic holes bored by carpenter bees so as to provide a primary attractant for carpenter bees. In this regard, the holes 12 are preferably between ½ inch and 3/4 inch in diameter. The holes 12 are preferably angled upwards from horizontal by an angle α, as shown in FIG. 2. The upward sloping holes 12 mimics the preferred entrance style of a natural carpenter bee nest and also reduces the amount of ambient light entering the entrance chamber 30, which is important for trapping the bees in the trap chamber 40. The angle a is preferably between 10 and 60 degrees.

In operation, carpenter bees are attracted to the holes 12 and enter the entrance chamber 30 via holes 12. Once in the entrance chamber 30, the bees are then attracted to the ambient light in the trap chamber 40 (that they can see via the gap 24 in the embodiment of FIG. 3A or holes 25 in the embodiment of FIG. 3B) as a possible exit route. The ambient light in the trap chamber 40 enters the trap chamber 40 via the trap chamber section 28 of the front panel 20. As discussed above, angling the holes 12 upward reduces the amount of ambient light entering the entrance chamber 30 via the holes 12, thereby reducing, if not eliminating, the chances of bees exiting the enclosure 10 via the holes 12. In experiments, bees that fully entered the entrance chamber 30 were never observed to escape via the holes 12 despite the absence of a physical labyrinth.

Attracted by the ambient light in the trap chamber, the bees fly into the trap chamber, where they are trapped and eventually die. This is because many flying insects, including carpenter bees, rely heavily on ambient light for navigation and orientation. As a result, bees trapped in the trap chamber 40 only try to escape through the trap chamber section 28 of the front panel 20 through which ambient light enters.

In the illustrated embodiment, the window 29 may be moved by sliding it along guides 32 to gain access to the trap chamber 40 in order to discard dead bees. However, as discussed above, any of the side panels 14, back panel 18 and/or bottom panel 24 may be movably attached for providing access to the trap chamber 40.

Experimental observation has shown that carpenter bee traps containing live bees were significantly more productive than empty traps or traps containing only dead bees. Live bees in the trap actively make distressed buzzing noises Which appear to be an attractant. A sound making device which mimics the sounds of a trapped bee can be inserted in the enclosure 10 to enhance its effectiveness. An electronic player similar to those used in talking greeting cards or a motor buzzer such as a vibrating cell phone alert device are two possible options for adding the sound attractant feature. Electrical power for the device may come from a storage battery or solar panel mounted on the enclosure 10 or a combination of the two. Since carpenter bees are most active during daytime, direct solar power can provide the required power at the appropriate times.

The foregoing embodiments and advantages are merely exemplary, and are not to be construed as limiting the present invention. The description of the present invention is intended to be illustrative, and not to limit the scope of the claims. Many alternatives, modifications, and variations will be apparent to those skilled in the art. Various changes may be made without departing from the spirit and scope of the invention.

What is claimed is:

1. A carpenter bee trap, comprising:
an enclosure;
a divider positioned inside the enclosure for dividing an interior of the enclosure into an entrance chamber and trap chamber, wherein at least a portion of the enclosure is adapted to allow ambient light to enter the trap chamber; and
at least one hole extending from an outside surface of the enclosure to the entrance chamber;
wherein the divider is configured to so as to provide one or more openings through which carpenter bees can enter the trap chamber from the entrance chamber.

2. The carpenter bee trap of claim 1, wherein the portion of the enclosure that is adapted to allow ambient light to enter the trap chamber comprises an optically transparent material.

3. The carpenter bee trap of claim 2, wherein the optically transparent material is movably attached so as to allow the optically transparent material to be selectively moved to allow access to the trap chamber.

4. The carpenter bee trap of claim 3, wherein the optically transparent material comprises a window that is movable to allow access to the trap chamber.

5. The carpenter bee trap of claim 1, wherein the portion of the enclosure that is adapted to allow ambient light to enter the trap chamber comprises an opaque material that is perforated to allow ambient light to enter the trap chamber.

6. The carpenter bee trap of claim 5, wherein the perforated opaque material comprises a perforated panel that is movably attached so as to allow the panel to be selectively moved to allow access to the trap chamber.

7. The carpenter bee trap of claim 6, wherein the perforated opaque material comprises a mesh screen.

8. The carpenter bee trap of claim 1, wherein the at least one hole is sized and shaped to so as to be an attractant for carpenter bees.

9. The carpenter bee trap of claim 1, wherein the diameter of the at least one hole is between 1/2 inch and ¾ inch.

10. The carpenter bee trap of claim 1, wherein the at least one hole extends at an upward angle from an outside surface of the enclosure to the entrance chamber.

11. The carpenter bee trap of claim 10, wherein the angle of the hole with respect to horizontal is between 10 and 60 degrees.

12. The carpenter bee trap of claim 1, wherein the enclosure comprises two side panels, a back panel, a front panel, a top panel and a bottom panel.

13. The carpenter bee trap of claim 12, wherein the at least one hole is formed in at least of the side panels, back panel and front panel.

14. The carpenter bee trap of claim 12, wherein a portion of at least one panel is adapted to allow ambient light to enter the trap chamber.

15. The carpenter bee trap of claim 12, wherein the portion of the at least one panel that is adapted to allow ambient light to enter the trap chamber is movably attached so as to allow it to be selectively moved to allow access to the trap chamber.

16. The carpenter bee trap of claim 12, wherein the portion of the at least one panel that is adapted to allow ambient light to enter the trap chamber comprises a window that is movable to allow access to the trap chamber.

17. The carpenter bee trap of claim 1, wherein the divider is sized and positioned so as to provide a gap between the divider and an enclosure wall that allows carpenter bees to enter the trap chamber from the entrance chamber.

18. The carpenter bee trap of claim 1, wherein the divider comprises at least one hole that allows carpenter bees to enter the trap chamber from the entrance chamber.

19. The carpenter bee trap of claim 1, wherein the divider is positioned inside the enclosure in an angled configuration.

20. The carpenter bee trap of claim 1, wherein the enclosure is formed of wood or a wood substitute.
